(19) United States
(12) Patent Application Publication
(10) Pub. No.: US 2013/0339261 A1
(43) Pub. Date: Dec. 19, 2013

(54) COMPUTER PRODUCT, INFORMATION PROVIDING METHOD, AND INFORMATION PROVIDING APPARATUS

(71) Applicant: FUJITSU LIMITED, Kawasaki-shi (JP)

(72) Inventor: Hitoshi ODA, Kawasaki (JP)

(73) Assignee: FUJITSU LIMITED, Kawasaki-shi (JP)

(21) Appl. No.: 13/857,575

(22) Filed: Apr. 5, 2013

(30) Foreign Application Priority Data
Jun. 15, 2012 (JP) 2012-136317

(51) Int. Cl. G06Q 10/10

(52) U.S. Cl. CPC G06Q 10/105
USPC 705/320

(57) ABSTRACT

A computer-readable recording medium stores a program causing a computer to execute a process that includes acquiring user information indicating a business unit to which a user belongs in a hierarchical organizational structure of business units; identifying information concerning a first service available to a member of the business unit to which the user belongs, by referring to storage contents of a storage unit correlating and storing information concerning a service available to a member of the business unit and information concerning the business units in neighboring tiers adjacent to a tier of the business unit; identifying information concerning a second service available to a member of a second business unit in a first neighboring tier adjacent to the tier of the business unit, by referring to the storage contents of the storage unit; and correlating and outputting the identified information concerning the first service and the second service.

### CROSS REFERENCE TO RELATED APPLICATIONS

This application is based upon and claims the benefit of priority of the prior Japanese Patent Application No. 2012-136317, filed on Jun. 15, 2012, the entire contents of which are incorporated herein by reference.

### FIELD

The embodiments discussed herein are related to a computer product, an information providing method, and an information providing apparatus.

### BACKGROUND

A portal site is a website that is an entrance used when the World Wide Web (WWW) is accessed. According to technique referred to as “enterprise information portal”, contents concerning services available to employees of Company A are displayed being consolidated as a “portlet” on a portal screen of a portal site that is accessible by the employees. The services provided by the enterprise information portal and available to a business unit of the company may differ according to the business unit. An employee may be able to use not only the services for a business unit to which the employee belongs but also the services for a business unit that is a higher-order organization of the business unit.

A related prior art includes, for example, a technique according to which, when a request for viewing information is issued from an employee, user authentication is executed for the employee and a portal screen incorporated with only the content set corresponding to the attribute and the working state of the employee is produced and is transmitted to a terminal. Another technique is present that is related to a security processing scheme to protect data in an electronic file or on a database of a computer. Yet another technique is related to a menu production system to produce a menu that corresponds to the authority of a user (see, for example, Japanese Laid-Open Patent Publications Nos. 2003-006424, H08-153042, and 2007-065971).

However, according to the conventional techniques, a problem arises in that when the organization of Company A, etc. is changed, the work load necessary for identifying a service to be provided for a user on the portal screen, etc. increases. For example, in Company A employing a division system, an “X” department that is a subordinate organization of a division may be transferred to be a subordinate organization of another division. In this case, for example, when business units from the business unit to which an employee belongs, up to the highest-order business unit thereof are regarded as one business unit (the one to which the employee belongs) and services that are available to the business unit to which the employee belongs are managed, information that indicates the business unit to which each of the employees of the X department belongs has to be changed. Therefore, the work to change the information is troublesome.

### SUMMARY

According to an aspect of an embodiment, a computer-readable recording medium stores an information providing program that causes a computer to execute a process that includes acquiring user information that indicates a business unit to which a user belongs in an organizational structure hierarchically structured by a plurality of business units; identifying information concerning a first service available to a member of the business unit to which the user belongs as indicated by the acquired user information, by referring to storage contents of a storage unit correlating and storing information concerning a service available to members of the business unit and information concerning the business units in neighboring tiers adjacent to a tier of the business unit; identifying information concerning a second service available to a member of a second business unit in a first neighboring tier adjacent to the tier of the business unit to which the user belongs, by referring to the storage contents of the storage unit; and correlating and outputting the identified information concerning the first service and the identified information concerning the second service.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of an information providing method according to a first embodiment;

FIG. 2 is an explanatory diagram of an example of system configuration of an information provision system 200;

FIG. 3 is a block diagram of a hardware configuration of an information providing apparatus 101 according to the embodiments;

FIG. 4 is an explanatory diagram of a specific example of an organizational structure;

FIG. 5 is an explanatory diagram of an example of the storage contents of a user information DB 210;

FIG. 6 is an explanatory diagram (Part I) of an example of the storage contents of a role information DB 220;

FIG. 7 is an explanatory diagram of an example of the storage contents of a service information DB 230;

FIG. 8 is a block diagram of an example of a functional configuration of an information providing apparatus 101;

FIG. 9 is an explanatory diagram of an example of the storage contents of a service list 900;

FIG. 10 is an explanatory diagram (Part I) of an example of a screen of a portal screen;

FIG. 11 is an explanatory diagram (Part I) of an example of updating of the storage contents of the role information DB 220 according to a second embodiment;

FIG. 12 is an explanatory diagram (Part II) of an example of updating of the storage contents of the role information DB 220 according to the second embodiment;

FIG. 13 is an explanatory diagram (Part III) of an example of updating of the storage contents of the role information DB 220 according to the second embodiment;

FIG. 14 is an explanatory diagram (Part IV) of an example of updating of the storage contents of the role information DB 220 according to the second embodiment;

FIG. 15 is a flowchart of an example of an information provision process procedure of the information providing apparatus 101 according to the second embodiment;

FIGS. 16 and 17 are flowcharts of an example of an updating process procedure of the information providing apparatus 101 according to the second embodiment;

FIG. 18 is an explanatory diagram (Part II) of another example of the storage contents of the role information DB 220;

FIG. 19 is an explanatory diagram (Part II) of an example of a screen of the portal screen;

FIG. 20 is an explanatory diagram (Part I) of an example of updating of the storage contents of the role information DB 220 according to a third embodiment;

FIG. 21 is an explanatory diagram (Part II) of an example of updating of the storage contents of the role information DB 220 according to the third embodiment;

FIG. 22 is an explanatory diagram (Part III) of an example of updating of the storage contents of the role information DB 220 according to the third embodiment;

FIG. 23 is an explanatory diagram (Part IV) of an example of updating of the storage contents of the role information DB 220 according to the third embodiment;

FIG. 24 is a flowchart of an example of the information provision process procedure of the information providing apparatus 101 according to the third embodiment;

FIG. 25 is a flowchart of an example of a specific process procedure of a first registration process; and

FIG. 26 is a flowchart of an example of a specific process procedure of a second registration process.

### DESCRIPTION OF EMBODIMENTS

Preferred embodiments of the present invention will be explained with reference to the accompanying drawings.

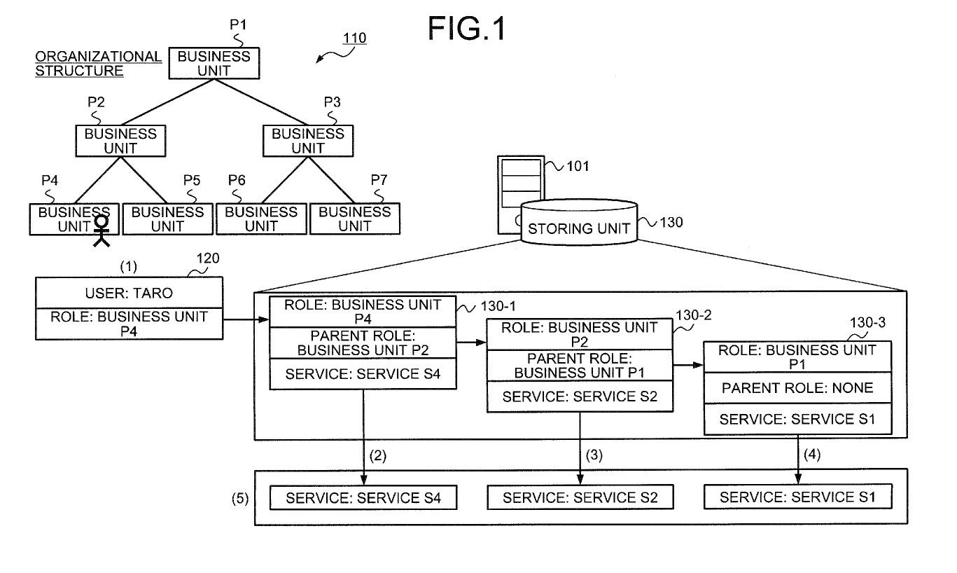

FIG. 1 is an explanatory diagram of an example of an information providing method according to a first embodiment. In FIG. 1, an information providing apparatus 101 is a computer that provides information concerning services available to a user who belongs to a business unit of an organizational structure that is hierarchically structured by plural business units.

The term “organization” used herein means a group whose roles and functions are differentiated and/or consolidated among its members to achieve a goal common. The organization can be, for example, Company A, a local government, a school, or a corporation. The term “business unit” used herein means a segment established according to its role, its task, its mission, etc. in an organization. The business unit can be, for example, a department, a section, a team, or a band in Company A, or a department, a course, a laboratory, or a group in a school.

The organizational structure of an organization is hierarchically structured by plural business units. For example, the organizational structure of the organization is a small structure that is hierarchically structured employing each business unit of the plural business units as a node. The example of FIG. 1 depicts an organizational structure 110 that is hierarchically structured adopting each of business units P1 to P7 as a node.

For a business unit, services that are available to the members of the business unit are defined. The term “service” used herein means, for example, an information process provided for a computer. The service can be, for example, a service of presenting the telephone number, the email address, the schedule, etc. of a member belonging to the business unit; a service of presenting the goal and the mission of the business unit; a service for a member of the business unit to make a reservation of a facility that is available for the members of the business unit; etc.

For a business unit, the same services as those for another business unit may be defined as the services available for the business unit. Business units may be present for which no service available therefor is defined.

A user can use services defined for the business unit to which the user belongs. The user may use services defined for a business unit in tiers higher and lower than that of the business unit to which the user belongs.

It is assumed that services S1, S2, and S4 are respectively defined for business units P1, P2, and P4. In this case, for example, a member belonging to the business unit P4 can use not only the service S4 defined for the business unit P4 but also the services S1 and S2 respectively defined for the business units P1 and P2 that are related to the business unit P4, of the business units P1 to P3 in a tier higher than that of the business unit P4.

On the other hand, the organizational structure of an organization may be changed. When the organizational structure of an organization is changed, the services available for the users are also changed. At this time, for example, in the case where, regarding the business units from the business unit to which the user belongs to the highest-order business unit as one role, the services available are managed in the one role, when the organizational structure is changed, the work is troublesome to change the information used to identify the services available for the user. The term “role” used herein means the business unit to which the user belongs.

For example, a case is assumed where the business unit P4 that is a subordinate organization of the business unit P2 is transferred to be a subordinate organization of the business unit P3 in the organizational structure 110. In this case, for all the users belonging to the business unit P4, the information to identify the role of the users is changed from “the business units P1, P2, and P4” to “the business units P1, P3, and P4” and the work load necessary for the work to change the manager, etc., is increased.

In the embodiment, the information providing apparatus 101 reduces the work load necessary for changing the information (“user information” described later) used to identify the role of a user when the organizational structure is changed, by regarding only the business unit to which the user belongs as the role of the user. The information providing apparatus 101 enables identification of not only the services for the business unit to which the user belongs but also the services for another business unit related thereto, by retaining information (“role information” described later) to trace the relation between business units in different tiers.

An example of processing of an information provision process by the information providing apparatus 101 will be described below. In the description, an arbitrary business unit of the business units P1 to P7 included in the organizational structure 110 may be written as “business unit P”. A service available to a member who belongs to the business unit P may be written as “service S”.

(1) The information providing apparatus 101 acquires user information of a user. In this acquisition, the user information is, for example, information that indicates the business unit to which the user belongs in the organizational structure 110. In the example of FIG. 1, user information 120 is acquired that indicates as a role the business unit name “P4” of the business unit P4 to which a user “Taro” belongs.

(2) The information providing apparatus 101 refers to the storage contents of a storage unit 130 and identifies a service available to a member of a business unit indicated by the acquired user information. The storage unit 130 is a storage device storing the role information. role information is business unit information for each business unit P and indicates information concerning the service S available to a member of the business unit P and information concerning another business unit in a neighboring tier adjacent to the tier of the business unit P, correlating the information. Another business unit in the neighboring tier is a business unit that is in a tier immediately above or immediately below the tier of the business unit P and that is related to the business unit P. Information concerning the service S is, for example, identification information of the service S.

In the example of FIG. 1, records of role information 130-1 to 130-3 are stored that each indicate the information concerning the service S available for the member of the business unit P and the information concerning another business unit representing a parent role of the business unit P, correlating the information. The parent role is a business unit in a tier immediately above the tier of the business unit P and is a business unit that is related to the business unit P. In this case, the information providing apparatus 101 refers to the role information 130-1 concerning the business unit P4 and identifies the service S4 available for the member of the business unit P4 indicated by the user information 120.

(3) The information providing apparatus 101 refers to the storage contents of the storage unit 130 and identifies a service available to a member of another business unit in a neighboring tier that is adjacent to the tier of the business unit to which the user belongs indicated by the acquired user information. In the example of FIG. 1, the information providing apparatus 101 refers to the role information 130-1 concerning the business unit P4, identifies the business unit P2 that indicates the parent role of the business unit P4 indicated by the user information 120, refers to the role information 130-2 concerning the business unit P2, and identifies the service S2 available to a member of the business unit P2.

(4) When yet another business unit is present in a neighboring tier adjacent to the tier of the other business unit, the information providing apparatus 101 refers to the storage contents of the storage unit 130 and identifies a service available to a member of the yet another business unit. In the example of FIG. 1, the information providing apparatus 101 refers to the role information 130-2 concerning the business unit P2, identifies the business unit P1 that represents the parent role of the business unit P2, refers to the role information 130-3 concerning the business unit P1, and identifies the service S1 available for the member of the business unit P1.

In (4), when another business unit is present that represents the parent role of the business unit P1, the information providing apparatus 101 refers to the storage contents of the storage unit 130 and identifies the service available for the member of the other business unit. In the example of FIG. 1, the business unit P1 is the business unit in the highest tier and therefore, no other business unit is present that represents the parent role of the business unit P1.

(5) The information providing apparatus 101 outputs the information concerning the identified service. In the example of FIG. 1, the information providing apparatus 101 correlates and outputs the identified information concerning the services S4, S2, and S1.

As described, according to the information providing apparatus 101 according to the first embodiment, when the organization of Company A, etc. is changed, the work load necessary for identifying services to be provided to the user can be reduced. For example, according to the information providing apparatus 101, the work load necessary to change the user information when the organizational structure is changed can be reduced by managing the user information using only the business unit to which the user belongs as the role of the user.

For example, in the organizational structure 110, when the business unit P4 that is a subordinate organization of the business unit P2 is transferred to be a subordinate organization of the business unit P3, a manager only has to change the parent role of the role information 130-1 from the “business unit P2” to the “business unit P3”. The manager does not need to change the user information concerning the user who belongs to the business unit P2. Therefore, the work load on the manager can be reduced when the organizational structure is changed compared to, for example, the case where the business units from the business unit to which the user belongs, up to the highest-order business unit there are regarded as one role.

According to the information providing apparatus 101, identification is enabled of not only the services for the business unit to which the user belongs but also the services for other business units relating to the business unit, by retaining the role information to trace the relation among business units in different tiers. According to the information providing apparatus 101, the work load necessary to change the user information when the organizational structure is changed is reduced and thereby, quick provision is enabled of the services corresponding to the business unit to which the user belongs when the organization structure is changed.

An information providing apparatus 101 according to a second embodiment will be described. Components identical to those described in the first embodiment will not again be described.

In the second embodiment, an organizational structure of Company A employing the division system will be used as an example of an organizational structure in the description. In the second embodiment, a case will be described where the user can use the services defined for the business unit to which the user belongs and the services defined for another business unit that is related to the business unit and that is in a tier higher than that of the business unit to which the user belongs.

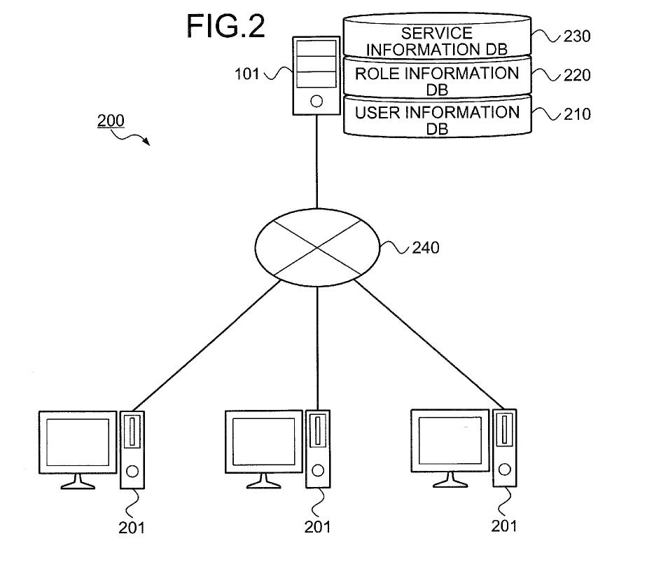

FIG. 2 is an explanatory diagram of an example of system configuration of an information provision system 200. In FIG. 2, the information provision system 200 includes the information providing apparatus 101 and plural (three in FIG. 2) client apparatuses 201. In the information provision system 200, the information providing apparatus 101 and the client apparatuses 201 are connected to each other through a wired or radio network 240. The network 240 is, for example, the Internet, a local area network (LAN), or a wide area network (WAN).

The information providing apparatus 101 includes a user information database (DB) 210, a role information DB 220, and a service information DB 230, and is a computer that provides information for the client apparatuses 201. For example, the information providing apparatus 101 provides screen information of a portal screen of a portal site for the client apparatuses 201. The information providing apparatus 101 is implemented by, for example, a web server, an application server, or a database server.

Each of the client apparatuses 201 is a computer including a browser to view the information. The client apparatus 201 is, for example, a personal computer (PC), a notebook PC, or a smartphone that is used by a user of the information provision system 200.

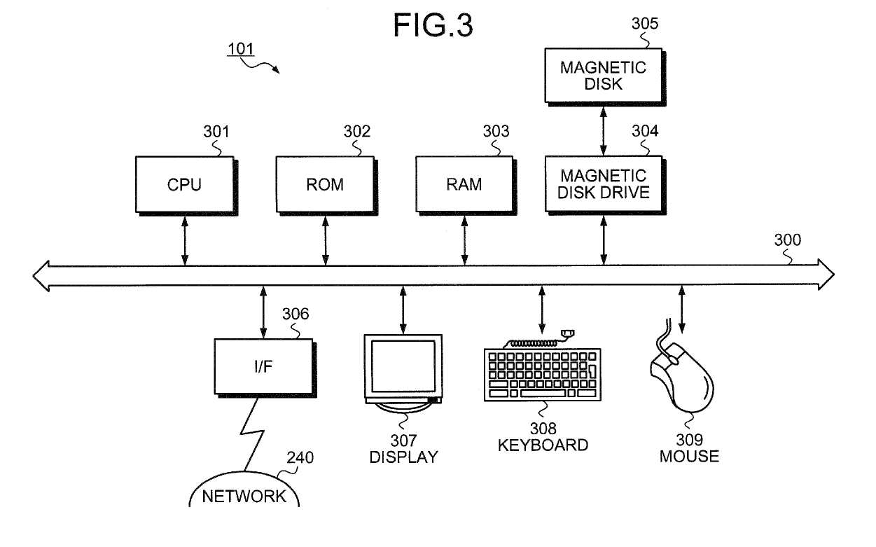

FIG. 3 is a block diagram of a hardware configuration of the information providing apparatus 101 according to the embodiments. As depicted in FIG. 3, the information providing apparatus 101 includes a central processing unit (CPU) 301, read-only memory (ROM) 302, random access memory (RAM) 303, a magnetic disk drive 304, a magnetic disk 305, an interface (I/F) 306, a display 307, a keyboard 308, and a mouse 309, respectively connected by a bus 300.

The CPU 301 governs overall control of the information providing apparatus 101. The ROM 302 stores therein programs such as a boot program. The RAM 303 is used as a work area of the CPU 301. The magnetic disk drive 304, under the control of the CPU 301, controls the reading and writing of data with respect to the magnetic disk 305. The magnetic disk 305 stores therein data written under control of the magnetic disk drive 304.

The I/F 306 is connected to the network 240 through a communication line and is connected to other apparatuses through the network 240. The I/F 306 administers an internal interface with the network 240 and controls the input and output of data with respect to external apparatuses. For example, a modem or a LAN adaptor may be employed as the I/F 306.

The display 307 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 307. The keyboard 308 includes, for example, keys for inputting letters, numerals, and various instructions and performs the input of data. The mouse 309 is used to move the cursor, select a region, or move and change the size of windows.

The information providing apparatus 101 may be configured omitting, for example, the display 207, the keyboard 308, and/or the mouse 309, among the components above. Further, the client apparatus 201 depicted in FIG. 2, for example, can be implemented by the same hardware configuration has the information providing apparatus 101.

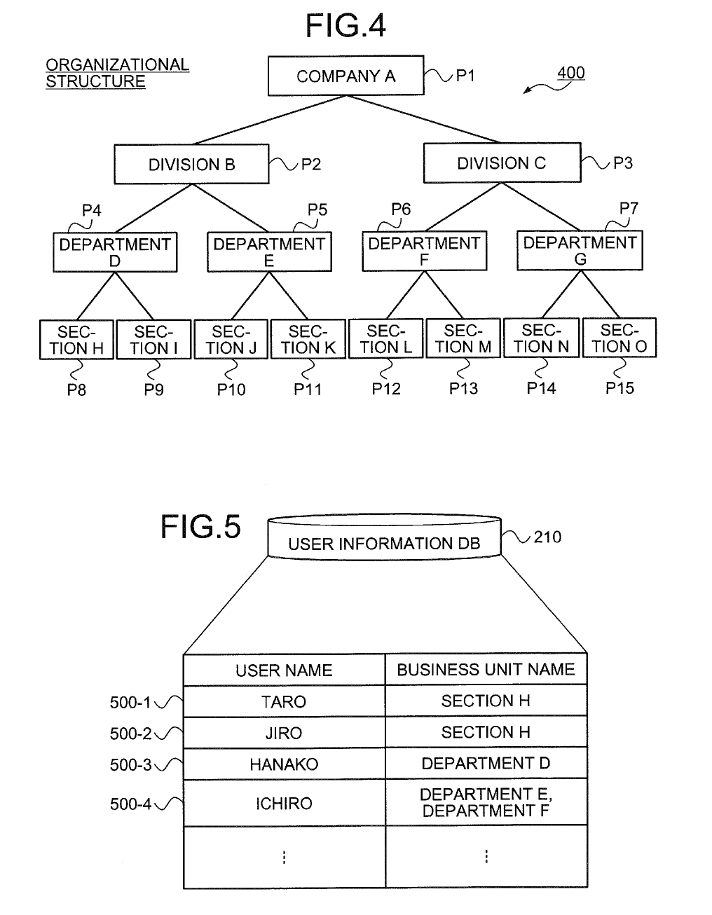

FIG. 4 is an explanatory diagram of a specific example of the organizational structure. In FIG. 4, the organizational structure 400 represents the organizational structure of Company A and is hierarchically structured by business units P1 to P15. In this case, Company A, divisions, departments, and sections are depicted as the business units.

For example, the organizational structure 400 includes, the business unit P1 “Company A” as the highest-order organization; the business units P2 “Department B” and P3 “Department C” as subordinate organizations of “Company A”; the business units P4 “Department D” and P5 “Department E” as subordinate organizations of the business unit P2 “Division B”; and the business units P6 “Department F” and P7 “Department G” as subordinate organizations of the business unit P3 “Division C”.

The organizational structure 400 also includes the business units P8 “Section H” and P9 “Section I” as subordinate organizations of the business unit P4 “Department D”; the business units P10 “Section J” and P11 “Section K” as subordinate organizations of the business unit P5 “Department E”; the business units P12 “Section L” and P13 “Section M” as subordinate organizations of the business unit P6 “Department F”; and the business units P14 “Section N” and P15 “Section 0” as subordinate organizations of the business unit P7 “Department G”.

In the following description, an arbitrary business unit of the business units P1 to P15 included in the organizational structure 400 may be written as “business unit Pi” (i=1, 2, . . . , 15).

The storage contents of each of the DBs 210 to 230 included in the information providing apparatus 101 will be described. The DBs 210 to 230 are each implemented by a storage device such as, for example, the RAM 303 or the magnetic disk 305 depicted in FIG. 3.

FIG. 5 is an explanatory diagram of an example of the storage contents of the user information DB 210. In FIG. 5, the user information DB 210 has fields for the user name and the business unit name. User information (for example, records of user information 500-1 to 500-4) is stored as records by entering information in each of the fields.

The user name is identification information used to identify a user of the information provision system 200 (see FIG. 2). The business unit name is identification information used to identify the business unit Pi to which the user belongs. When the user belongs to plural business units, the business unit name of each of the business units to which the user belongs is entered.

For example, according to the user information 500-1, the business unit “Section H” to which the user “Taro” belongs can be identified. According to the user information 500-4, the business units “Department E” and “Department F” to which a user “Ichiro” belongs can be identified.

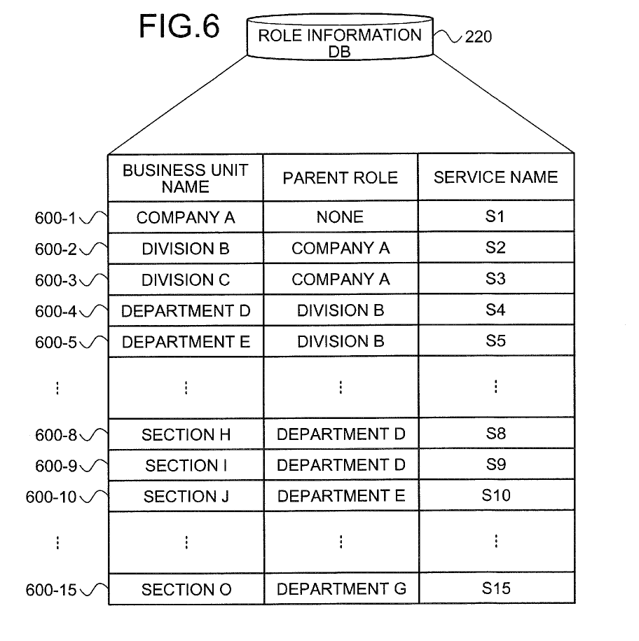

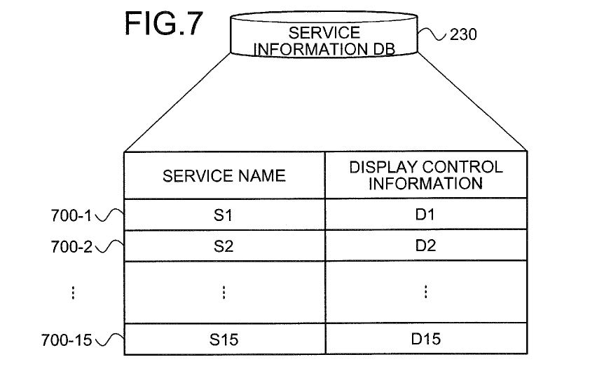

FIG. 6 is an explanatory diagram (Part I) of an example of the storage contents of the role information DB 220. In FIG. 6, the role information DB 220 has fields for the business unit name, the parent role, and the service name. Role information (for example, records of role information 600-1 to 600-15) is stored as records by entering information in each of the fields.

In this case, the business unit name is identification information used to identify the business unit Pi. The parent role represents a business unit that is a business unit in a tier immediately above that of the business unit Pi and that is related to the business unit Pi. The parent role represents a higher-order organization of the business unit Pi. The service name is identification information concerning the service available for the member belonging to the business unit Pi. In this case, the services S1 to S15 available for the members of the business units P1 to P15 are respectively defined for the business units P1 to P15.

For example, according to the role information 600-1, the service S1 available for the members of the business unit “Company A” and absence of the parent role for the business unit “Company A” can be identified. According to the role information 600-2, the service S2 available for the members of the business unit “Division B” and the parent role “Company A” of the business unit “Division B” can be identified.

In the following description, an arbitrary service of the services S1 to S15 may be written as “service Si” (i=1, 2, . . . , 15).

FIG. 7 is an explanatory diagram of an example of the storage contents of the service information DB 230. In FIG. 7, the service information DB 230 has fields for the service name and the display control information. Service information (for example, records of the service information 700-1 to 700-15) is stored as records by entering information in each of the fields.

In this case, the service name is identification information concerning the service Si available to a member belonging to the business unit Pi. The display control information is information used to display on the portal screen display information concerning the service Si. The display control information includes, for example, the Uniform Resource Locator (URL) that represents the storage location of the display information and information that indicates the position and the size of the information displayed on the portal screen. For example, according to the service information 700-1, display control information D1 concerning the service S1 can be identified.

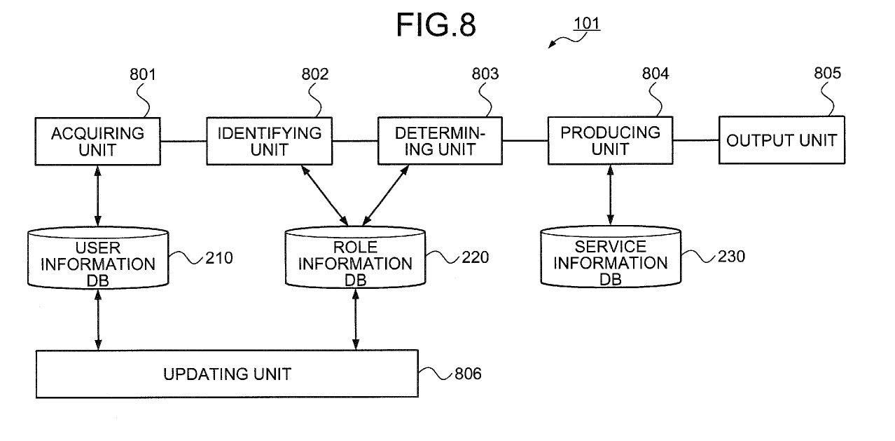

FIG. 8 is a block diagram of an example of a functional configuration of the information providing apparatus 101. In FIG. 8, the information providing apparatus 101 includes an acquiring unit 801, an identifying unit 802, a determining unit 803, a producing unit 804, an output unit 805, and an updating unit 806. The units from the acquiring unit 801 to the updating unit 806 are functions to be a control unit and are implemented by, for example, causing the CPU 301 to execute programs stored in a storage device such as the ROM 302, the RAM 303, or the magnetic disk 305 that are depicted in FIG. 3, or by using the I/F 306. The result of processing by each of the functional units is stored in a storage device such as the RAM 303 or the magnetic disk 305.

The acquiring unit 801 has a function of acquiring the user information of the user. The user information is, for example, information that indicates the business unit to which the user belongs in the organizational structure 400 (see FIG. 4), which is hierarchically structured by the business units P1 to P15. For example, the acquiring unit 801 receives log-in of the user and thereby, acquires the user name “Taro” of the user, and acquires the user information 500-1 that corresponds to the acquired user name “Taro” from the user information DB 210 depicted in FIG. 5.

The log-in process is executed using, for example, the client apparatus 201 depicted in FIG. 2. In the log-in process, an authentication process is executed using the user name and a password of the user. The acquiring unit 801 may acquire the user information by user input via, for example, the keyboard 308 and/or the mouse 309 depicted in FIG. 3.

The identifying unit 802 has a function of identifying services available to a member belonging to a target business unit. A target business unit is a business unit for which services available to its members are to be identified. For example, the identifying unit 802 sets the business unit “Section H” to which a user belongs and indicated by the acquired user information 500-1, to be the target business unit for which services are to be identified.

The identifying unit 802 acquires from the role information DB 220 depicted in FIG. 6, the role information 600-8 concerning the target business unit whose business unit name field has the business unit name “Section H” entered therein; and identifies the service name “S8” entered in the service name field of the acquired role information 600-8. Thereby, the service name “S8” of the service S8, which is available to the members of the business unit “Section H” to which the user “Taro” belongs, can be identified.

The determining unit 803 has a function of determining whether any other business unit is present that is in a tier immediately above the target business unit and that is related to the target business unit. For example, the determining unit 803 refers to the role information 600-8 concerning the target business unit for which services are identified by the identifying unit 802; and determines whether any parent role of the target business unit “Section H” is present. In the example of the role information 600-8, the business unit name “Department D” is entered in the parent role field. Therefore, the determining unit 803 determines that the parent role “Department D” of the target business unit “Section H” is present.

The identifying unit 802 also has a function of identifying, when the determining unit 803 determines that another business unit is present that is in a tier immediately above that of a target business unit and that is related to the target business unit, services available to members of the other business unit. For example, when the determining unit 803 determines that the parent role “Department D” of the target business unit “Section H” is present, the identifying unit 802 sets the parent role “Department D” to be a target business unit for which services are to be identified, and acquires from the role information DB 220, the role information 600-4 of the newly set target business unit and whose business unit name field has the business unit name “Department D” entered therein.

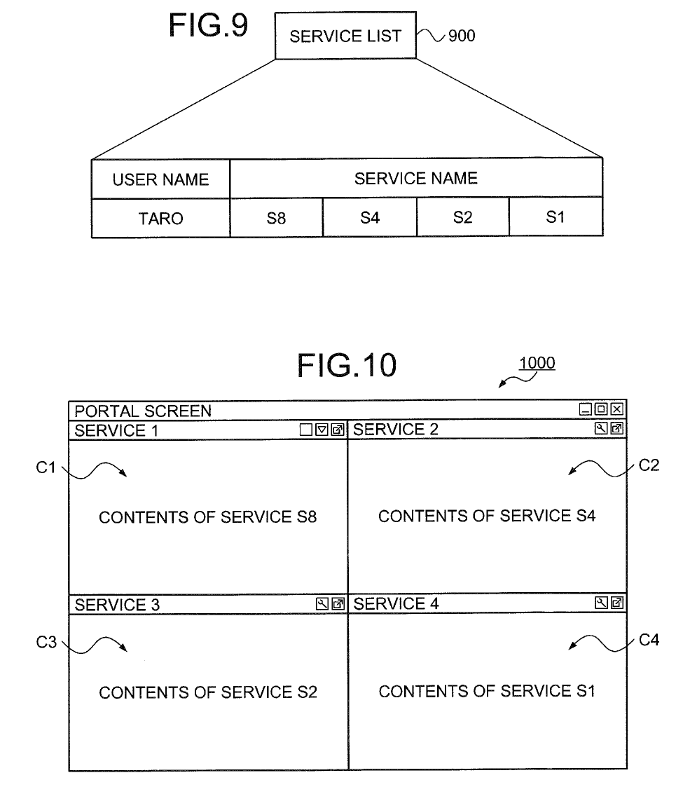

The identifying unit 802 identifies the service name “S4” entered in the service name field of the acquired role information 600-4. Thereby, the service name “S4” can be identified of the service S4 available for the members of the parent role “Department D” of the business unit “Section H” to which the user belongs. The identified service name is registered in, for example, a service list 900 depicted in FIG. 9.

FIG. 9 is an explanatory diagram of an example of the storage contents of the service list 900. In FIG. 9, the service list 900 is information indicating services available for the user. For example, the service list 900 indicates, as a list, the service names of the services S8, S4, S2, and S1 available to the user “Taro”. From the service list 900, the services S8, S4, S2, and S1 available to the user “Taro” can be identified.

Reference of the description returns to FIG. 8. The producing unit 804 has a function of producing screen information used to display contents concerning the service available to the user based on the information concerning the services identified by the identifying unit 802. For example, the producing unit 804 refers to the service list 900 depicted in FIG. 9 and produces screen information of a portal screen to display contents concerning the services S8, S4, S2, and S1 available to the user “Taro”.

For example, the producing unit 804 acquires from the service information DB 230, display control information D8, D4, D2, and D1 of the services S8, S4, S2, and S1 available to the user “Taro”; and based on the acquired display control information D8, D4, D2, and D1, produces screen information of the portal screen having the contents concerning the services S8, S4, S2, and S1 incorporated therein.

The output unit 805 has a function of outputting the screen information produced by the producing unit 804. The output form of the output unit 805 can be, for example, display on the display 307, transmission to an external computer by the I/F 306, or storage to a storage device such as the RAM 303 or the magnetic disk 305.

For example, the output unit 805 may transmit the screen information of the produced portal screen to the client apparatus 201 that received the log-in. As a result, the client apparatus 201 displays on its display, the portal screen based on the produced screen information. An example of a screen of the portal screen will be described later with reference to FIG. 10.

The output unit 805 may output the information of the services identified by the identifying unit 802, correlating this information with the identification information concerning the user. For example, the output unit 805 may output the service list 900 depicted in FIG. 9. Thereby, a computer other than the information providing apparatus 101 can produce the screen information concerning the portal screen to be provided for the client apparatus 201.

The updating unit 806 has a function of updating the role information based on an organizational change notification when the updating unit 806 receives a organizational change notification giving notification of the contents of the change in the organizational structure as a result of the change in the organizational structure. For example, when the updating unit 806 receives the organizational change notification concerning the organizational structure 400, the updating unit 806 updates the storage contents of the role information DB 220 based on the organizational change notification.

The organizational change notification can be, for example, a business unit transfer notification giving notification that a business unit is transferred, a business unit dismantling notification giving notification that a business unit is dismantled, a business unit name change notification giving notification that the name of a business unit is changed, and a business unit addition notification giving notification that a new business unit is added.

An organizational change notification concerning the organizational structure 400 is input to the information providing apparatus 101 by, for example, an operational input by the manager of the information provision system 200 using the keyboard 308 or the mouse 309. The information providing apparatus 101 may receive an organizational change notification concerning the organizational structure 400 from an external computer.

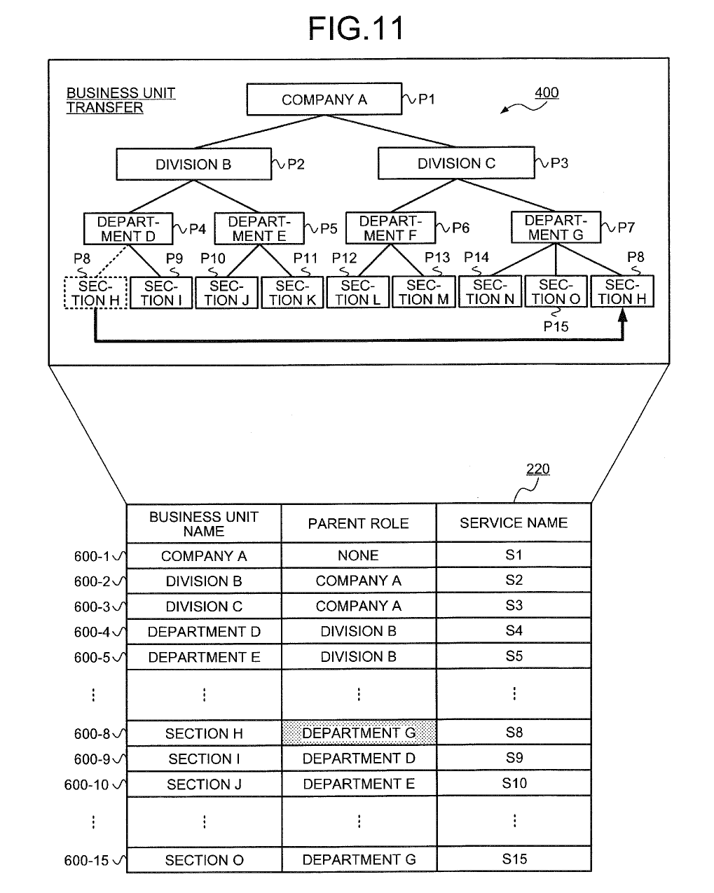

The updating unit 806 may update the user information based on an organizational change notification when the updating unit 806 receives an organizational change notification concerning details of the change in the organizational structure as a result of the change of the organizational structure. For example, when the updating unit 806 receives the organizational change notification concerning the organizational structure 400, the updating unit 806 updates the storage contents of the user information DB 210 based on the organizational change notification. The specific contents of the process by the updating unit 806 will be described later with reference to FIGS. 11 to 14.

In the above description, when the updating unit 806 receives the organizational change notification concerning the organizational structure 400, the updating unit 806 updates the storage contents of the user information DB 210 and the role information DB 220. However, the manner of updating is not limited hereto. For example, the manager of the information provision system 200 may manually update the storage contents of each of the user information DB 210 and the role information DB 220.

FIG. 10 is an explanatory diagram (Part I) of an example of a screen of the portal screen. In FIG. 10, a portal screen 1000 is an example of screen that displays the contents concerning the services S8, S4, S2, and S1 available for the user “Taro”.

For example, the portal screen 1000 has contents C1, C2, C3, and C4 incorporated therein that respectively concern the service S8 available to the members of the business unit “Section H”, the service S4 available to the members of the business unit “Department D”, the service S2 available to the members of the business unit “Division B”, and the service S1 available to the members of the business unit “Company A”.

According to the portal screen 1000, the user “Taro” can refer to the contents C1 to C4 that respectively concern the services S8, S4, S2, and S1, which are available for the business unit “Section H” to which the user “Taro” belongs, and the business units “Department D”, “Division B”, and “Company A” that are higher-order organizations of the business unit “Section H”.

Examples of updating of the storage contents of the role information DB 220 executed when the organizational change of the organizational structure 400 is executed will be described with reference to FIGS. 11 to 14.

FIG. 11 is an explanatory diagram (Part I) of an example of updating of the storage contents of the role information DB 220 according to the second embodiment. The example depicted in FIG. 11 is an example for a case where the business unit “Section H” that is a subordinate organization of the business unit “Department D” is transferred to be a subordinate organization of the business unit “Department G”.

When the updating unit 806 receives an organizational change notification giving notification that the business unit “Section H” is transferred to be a subordinate organization of the business unit “Department G”, the updating unit 806 acquires from the role information DB 220, the role information 600-8 whose business unit name field has the business unit name “Section H” entered therein and enters the business unit name “Department G” into the parent role field of the acquired role information 600-8.

Thus, the parent role of the business unit to be transferred can be updated simultaneously with the transfer of the business unit in the company.

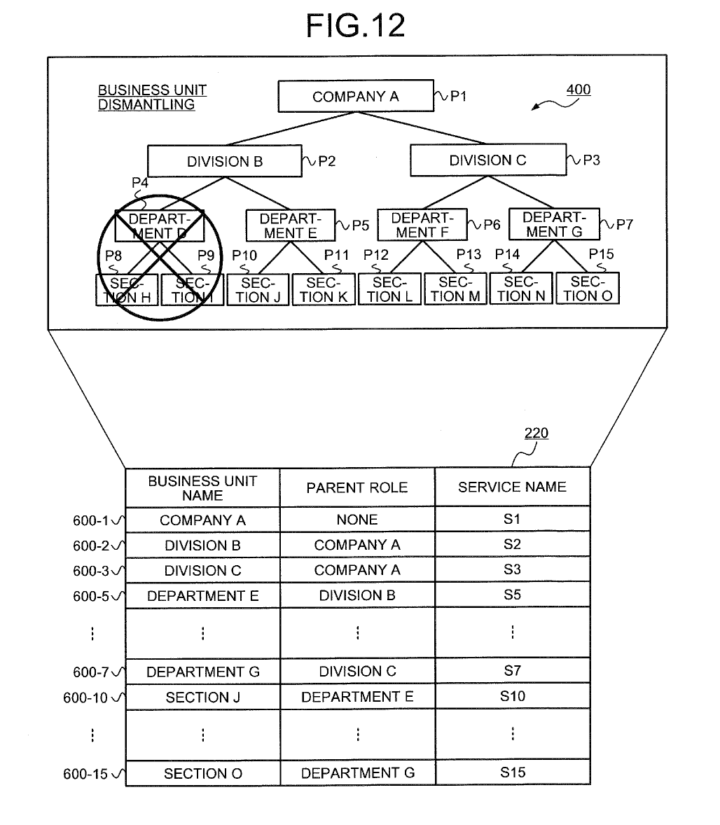

FIG. 12 is an explanatory diagram (Part II) of an example of updating of the storage contents of the role information DB 220 according to the second embodiment. The example depicted in FIG. 12 is an example for a case where the business unit “Department D” is dismantled. The business units “Section H” and “Section I” that are the subordinate organizations of the business unit “Department D” are also dismantled accompanying the dismantling of the business unit “Department D”.

When the updating unit 806 receives an organizational change notification giving notification that the business units “Department D”, “Section H”, and “Section I” are dismantled, the updating unit 806 deletes from the role information DB 220, the records of role information 600-4, 600-8, and 600-9 whose business unit name fields respectively have the business unit names “Department D”, “Section H”, and “Section I” entered therein.

Thus, the role information of the business units to be dismantled can be deleted from the role information DB 220 simultaneously with the dismantling of the business units in the company.

In this case, the updating unit 806 may delete from the user information DB 210, the user information whose business unit name field has entered therein the business unit name of the business unit to be dismantled. Thus, the user information of the user belonging to the business unit to be dismantled can be deleted simultaneously with the dismantling of the business units in the company.

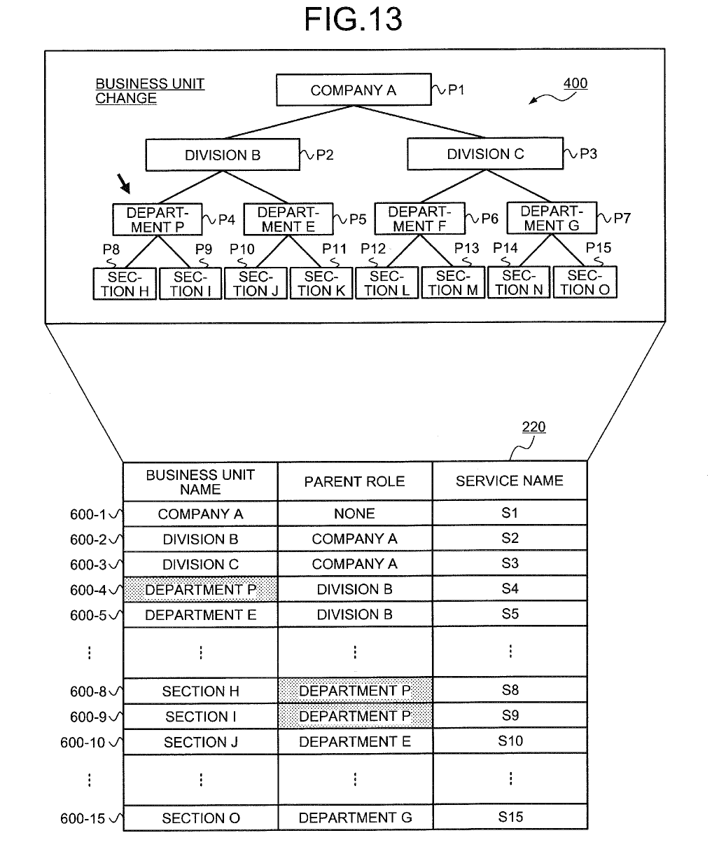

FIG. 13 is an explanatory diagram (Part III) of an example of updating of the storage contents of the role information DB 220 according to the second embodiment. The example depicted in FIG. 13 is an example for a case where the business unit name of the business unit “Department D” is changed. In this case, it is assumed that the business unit name after the change is “P Department”.

When the updating unit 806 receives an organizational change notification giving notification that the business unit name of the business unit “Department D” is changed to “P Department”, the updating unit 806 acquires from the role information DB 220, the role information 600-4 whose business unit name field has the business unit name “Department D” entered therein. The updating unit 806 enters the business unit name “P Department” into the business unit name field of the acquired role information 600-4.

Thus, the role information whose business unit name field has entered therein the business unit name of the business unit to be changed, can be updated simultaneously with the change of the business unit name of the business unit in the company.

The updating unit 806 acquires from the role information DB 220, the records of role information 600-8 and 600-9 whose parent role fields have the business unit name “Department D” entered therein and enters the business unit name “P Department” into the parent role fields of the acquired records of role information 600-8 and 600-9.

Thereby, the records of role information whose parent role fields have entered therein the business unit name of the business unit to be changed can be updated simultaneously with the change of the business unit name of the business unit in the company.

In this case, the updating unit 806 may acquire from the user information DB 210, the user information whose business unit name field has entered therein the business unit name of the business unit to be changed and may enter the new business unit name into the business unit name field. Thereby, the user information of the user belonging to the business unit whose name is to be changed can be updated simultaneously with the change of the business unit name of the business unit in the company.

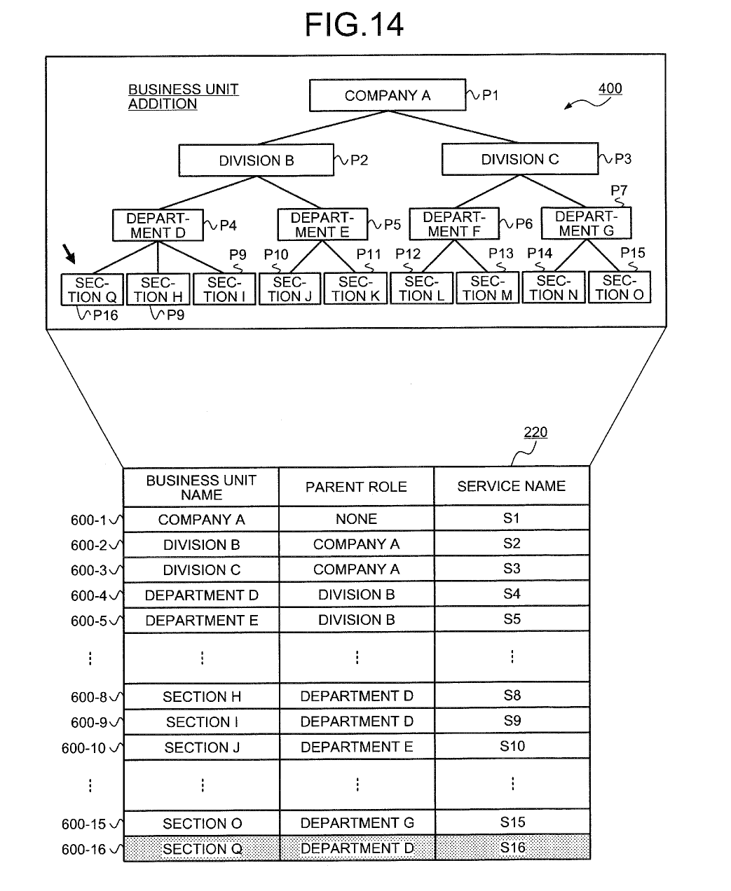

FIG. 14 is an explanatory diagram (Part IV) of an example of updating of the storage contents of the role information DB 220 according to the second embodiment. The example depicted in FIG. 14 is an example for a case where a new business unit “Q Section” is added as a subordinate organization of the business unit “Department D”.

When the updating unit 806 receives an organizational change notification giving notification that the new business unit “Q Section” is added as a subordinate organization of the business unit “Department D”, the updating unit 806 newly registers role information 600-16 into the role information DB 220. The organizational change notification includes, for example, a service name “S16” of the service S16 available to the members of the new business unit “Q Section”.

For example, the updating unit 806 enters “Q Section” into the business unit name field of the role information DB 220, “Department D” in the parent role field, and “S16” in the service name field and thereby, the role information DB 220 is stored as a new record. Thus, the role information of the new business unit can be newly registered simultaneously with the addition of the new business unit in the company.

When the new business unit is added, the user information concerning each of the members of the new business unit is newly registered into the user information DB 210 and the service information concerning each of the services available for the members of the new business unit is newly registered into the service information DB 230.

Process procedures of the information providing apparatus 101 according to the second embodiment will be described. An information provision process procedure of the information providing apparatus 101 according to the second embodiment will be described.

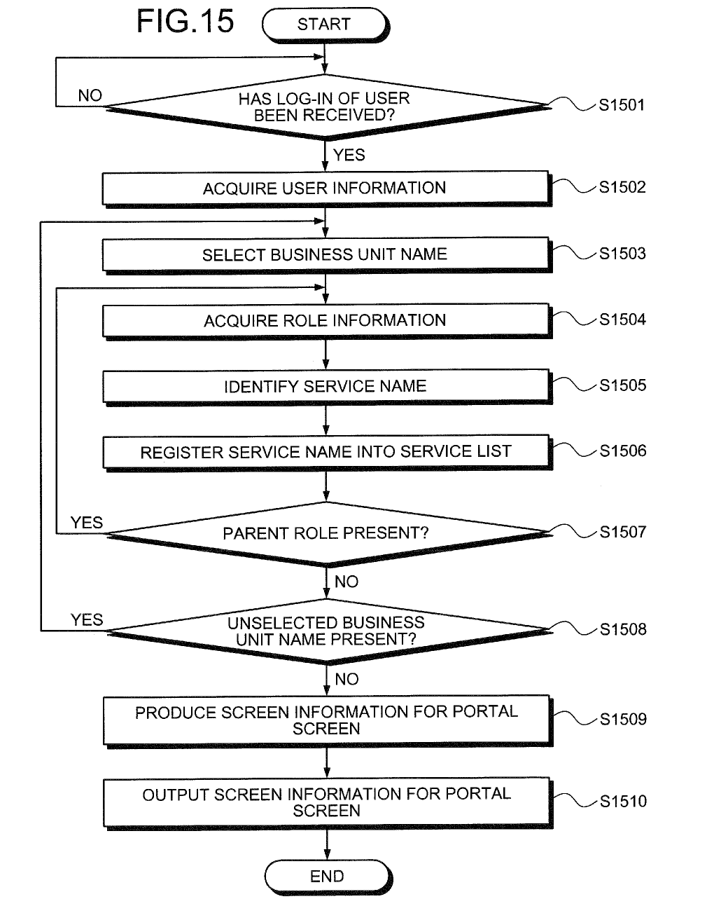

FIG. 15 is a flowchart of an example of the information provision process procedure of the information providing apparatus 101 according to the second embodiment. In the flowchart of FIG. 15, the information providing apparatus 101 determines whether log-in of a user has been received from the client apparatus 201 (step S1501).

The information providing apparatus 101 waits for log-in of the user to be received (step S1501: NO). Upon receiving log-in of the user (step S1501: YES), the information providing apparatus 101 acquires from the user information DB 210, the user information of the user (step S1502).

The information providing apparatus 101 selects the business unit name entered in the business unit name field of the acquired user information (step S1503) and acquires from the role information DB 220, the role information whose business unit name field has entered therein the acquired business unit name (step S1504).

The information providing apparatus 101 identifies the service name entered in the service name field of the acquired role information (step S1505), registers the identified service name into the service list 900 (step S1506), and determines whether a parent role is present, by referring to the acquired role information (step S1507).

If the information providing apparatus 101 determines that a parent role is present (step S1507: YES), the information providing apparatus 101 returns to step S1504 and acquires from the roll information DB 220, role information whose business unit name field has entered in the business unit name that is entered in the parent role field of the acquired role information (step S1504).

On the other hand, if the information providing apparatus 101 determines that no parent role is present (step S1507: NO), the information providing apparatus 101 determines whether an unselected business unit name that is entered in the business unit name field of the acquired user information is present (step S1508).

If the information providing apparatus 101 determines that an unselected business unit name is present (step S1508: YES), the information providing apparatus 101 returns to step S1503 and selects the unselected business unit name that is entered in the business unit name field of the acquired user information (step S1503).

On the other hand, if the information providing apparatus 101 determines that no unselected business unit name is present (step S1508: NO), the information providing apparatus 101 refers to the service list 900 and produces screen information for the portal screen that displays thereon contents concerning services available to the user (step S1509). The information providing apparatus 101 outputs the produced screen information for the portal screen to the client apparatus 201 (step S1510) and causes the series of operations according to the flowchart to come to an end.

Thus, when the log-in of the user is received, the screen information of the portal screen that displays thereon contents concerning the services available to the user can be provided for the client apparatus 201.

An updating process procedure of the information providing apparatus 101 according to the second embodiment will be described. The updating process is a process of updating the storage contents of the role information DB 220.

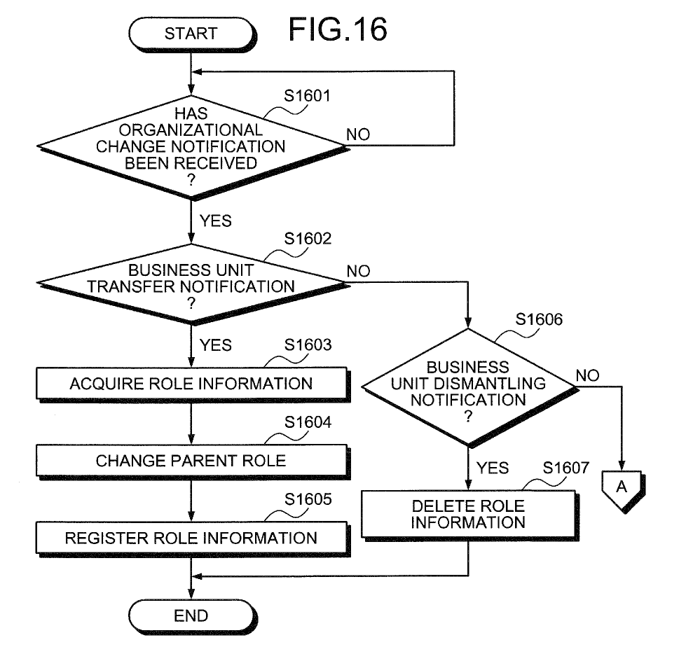

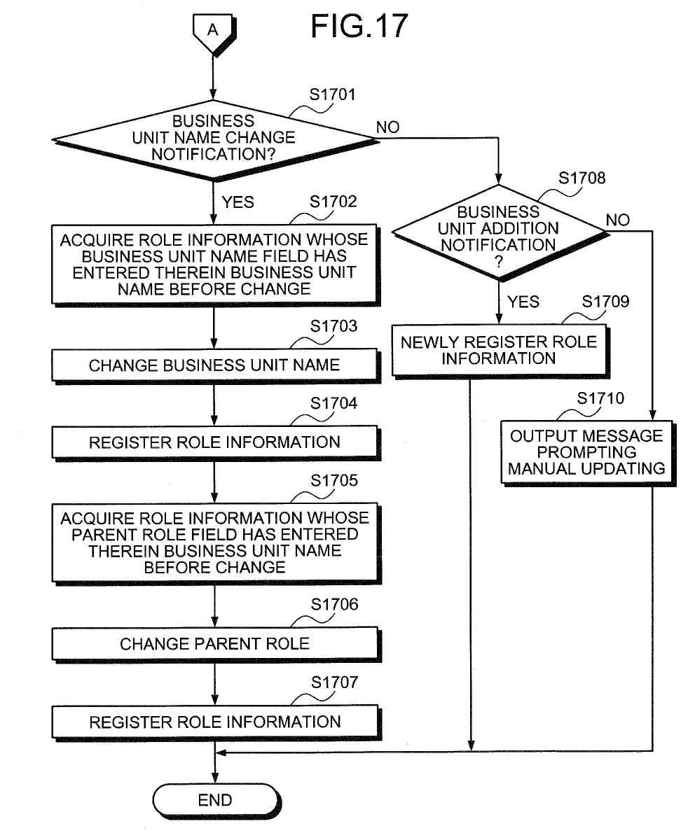

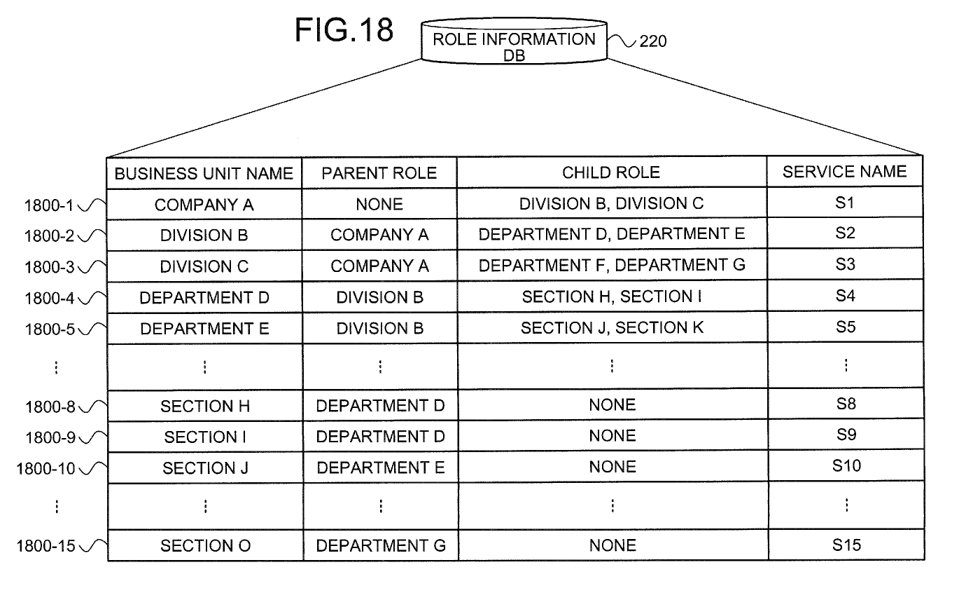

FIGS. 16 and 17 are flowcharts of an example of the updating process procedure of the information providing apparatus 101 according to the second embodiment. In the flowchart of FIG. 16, the information providing apparatus 101 determines whether an organizational change notification concerning the organizational structure has been received (step S1601).

The information providing apparatus 101 waits for an organizational change notification to be received (step S1601: NO). Upon receiving an organizational change notification (step S1601: YES), the information providing apparatus 101 determines whether the received organizational change notification is a business unit transfer notification (step S1602).

If the information providing apparatus 101 determines that the received organizational change notification is a business unit transfer notification (step S1602: YES), the information providing apparatus 101 acquires from the role information DB 220, the role information whose business unit name field has entered therein the business unit name of the business unit to be transferred (step S1603) and changes the parent role of the acquired role information (step S1604).

The information providing apparatus 101 registers into the role information DB 220, the new role information whose parent role is changed (step S1605) and causes the series of operations according to the flowchart to come to an end.

If the information providing apparatus 101 determines, at step S1602, that the organizational change notification is not a business unit transfer notification (step S1602: NO), the information providing apparatus 101 determines whether the organizational change notification is a business unit dismantling notification (step S1606). If the information providing apparatus 101 determines that the organizational change notification is a business unit dismantling notification (step S1606: YES), the information providing apparatus 101 deletes from the role information DB 220, the role information of the business unit to be dismantled (step S1607) and causes the series of operations to come to an end.

If the information providing apparatus 101 determines, at step S1606, that the organizational change notification is not a business unit dismantling notification (step S1606: NO), the procedure proceeds to step S1701 depicted in FIG. 17.

In the flowchart of FIG. 17, the information providing apparatus 101 determines whether the received organizational change notification is a business unit name change notification (step S1701). If the information providing apparatus 101 determines that the received organizational change notification is a business unit name change notification (step S1701: YES), the information providing apparatus 101 acquires from the role information DB 220, the role information whose business unit name field has entered therein the business unit name before the change (step S1702).

The information providing apparatus 101 changes the business unit name by entering the new business unit into the business unit name field of the acquired role information (step S1703) and registers into the role information DB 220, the new role information with the new business unit name (step S1704).

The information providing apparatus 101 acquires from the role information DB 220, the role information whose parent role field has entered therein the business unit name before the change (step S1705), changes the parent role by entering the new business unit name into the parent role field of the acquired role information (step S1706), registers into the role information DB 220, the new role information whose parent role has been changed (step S1707), and causes the series of operations according to this flowchart to come to an end.

If the information providing apparatus 101 determines at step S1701 that the organizational change notification is not a business unit name change notification (step S1701: NO), the information providing apparatus 101 determines whether the organizational change notification is a business unit addition notification (step S1708). If the information providing apparatus 101 determines that the organizational change notification is a business unit addition notification (step S1708: YES), the information providing apparatus 101 newly registers into the role information DB 220, the role information concerning the new business unit (step S1709) and causes the series of operations according to this flowchart to come to an end.

If the information providing apparatus 101 determines at step S1708 that the organizational change notification is not a business unit addition notification (step S1708: NO), the information providing apparatus 101 outputs a message to prompt manual updating of the role information DB 220 (step S1710) and causes the series of operations according to this flowchart to come to an end. Thus, the storage contents of the role information DB 220 can be updated simultaneously with an organizational change.

As described, according to the information providing apparatus 101 according to the second embodiment, by regarding only the business unit to which the user belongs as a role, the work load that is necessary to change the user information and the role information when the organizational structure is changed, can be reduced.

According to the information providing apparatus 101, assuming that the business unit to which the user belongs is a target business unit for which services are to be identified, the service names of services that are available to the members of the target business unit, can be identified by referring to the role information DB 220. According to the information providing apparatus 101, when a parent role is present for the target business unit, assuming that the parent role is a target business unit for which services are to be identified, the service names of services that are available to the members of the business unit can be identified. Thus, services can be identified as the services available to the user such as those available to the members of the business units from the business unit to which the user belongs, up to the highest-order business unit of the organizational structure.

According to the information providing apparatus 101, the screen information of the portal screen to display the contents concerning the services available to the user can be produced by referring to the service information DB 230. Thereby, the screen information of the portal screen corresponding to the business unit to which the user belongs can be provided for the client apparatus 201.

According to the information providing apparatus 101, when a change notification giving notification of the details of a change in the organizational structure is received as a result of the change of the organizational structure of the organization, the storage contents of the role information DB 220 can be updated based on the change notification. Thereby, the work load on the worker can be reduced for changing the role information associated with the change of the organizational structure.

According to the information providing apparatus 101, when a change notification giving notification of the details of a change in the organizational structure is received as a result of the change of the organizational structure of the organization, the storage contents of the user information DB 210 can be updated based on the change notification. Thereby, the work load on the worker can be reduced for changing the user information associated with the change of the organizational structure.

The information providing apparatus 101 according to a third embodiment will be described. Components identical to those described in the first and the second embodiments will not again be described.

In the third embodiment, a case will be described where the user can use the service defined for the business unit to which the user belongs, and the services defined for the business units that are in tiers higher and lower than that of the business unit to which the user belongs and that are related to the business unit to which the user belongs.

The storage contents of the role information DB 220 according to the third embodiment will be described. The organizational structure 400 depicted in FIG. 4 will be used in the description as an example of the organizational structure of Company A.

FIG. 18 is an explanatory diagram (Part II) of another example of the storage contents of the role information DB 220. In FIG. 18, the role information DB 220 has fields for the business unit name, the parent role, the child role, and the service name. Records of role information 1800-1 to 1800-15 are stored therein as records by entering information into each of the fields.

The child role is a business unit in a tier immediately below the tier of the business unit Pi and represents a business unit that is related to the business unit Pi. The child role represents a subordinate organization of the business unit Pi. For example, according to the role information 1800-1, the user can identify the service S1 available to the members of the business unit “Company A”, the absence of the parent role of the business unit “Company A”, and the child roles “Divisions B and C” of the business unit “Company A”. According to the role information 1800-2, the user can identify the service S2 available to the members of the business unit “Division B”, the parent role “Company A” of the business unit “Division B”, and the child roles “Departments D and E” of the business unit “Division B”.

Although a case has been described where only one parent role of the business unit Pi is present, plural parent roles may be present for the business unit Pi. In this case, the business unit names of the parent roles are entered into the parent role field of the business unit Pi.

Functional units of the information providing apparatus 101 according to the third embodiment will be described. An example of functional configuration of the information providing apparatus 101 according to the third embodiment is identical to that of the information providing apparatus 101 described in the second embodiment and therefore, will not again be depicted. Components will be described that differ from the description of the functional units of the information providing apparatus 101 described in the second embodiment.

The determining unit 803 has a function of determining whether any other business unit is present that is in the tier immediately below the tier of the target business unit and that is related to the target business unit. For example, it is assumed that the target business unit for which services are to be identified is the business unit “Department D”. In this case, the determining unit 803 refers to the role information 1800-4 of the target business unit and determines whether a child role of the target business unit “Department D” is present. In the example of the role information 1800-4, the business unit names “Sections H and I” are set in the child role field. Therefore, the determining unit 803 determines that the child roles “Sections H and I” of the target business unit “Department D” are present.

The identifying unit 802 has a function of identifying services available to the members of another business unit if the determining unit 803 determines that another business unit is present that is in the tier immediately below the tier of the target business unit and that is related to the target business unit. For example, when it is determined that the child roles “Sections H and I” of the target business unit “Department D” are present, the identifying unit 802 sets the child role “Section H” to be a target business unit, acquires from the role information DB 220, the role information 1800-8 whose business unit name field has entered therein the business unit name “Section H” of the target business unit, and identifies the service name “S8” that is entered in the service name field of the acquired role information 1800-8.

The identifying unit 802 sets the child role “Section I” to be a target business unit, acquires from the role information DB 220, the role information 1800-9 whose business unit name field has entered therein the business unit name “Section I” of the target business unit, and identifies the service name “S9” that is entered in the service name field of the acquired role information 1800-9.

Thus, the service names “S8 and S9” of the services S8 and S9 available to the members of the child roles “Sections H and I” of the business unit “Department D” to which the user belongs, can be identified. In the third embodiment, services can be identified that are available to the members of not only another business unit in a tier higher than that of the business unit to which the user belongs but also another related business unit that is in a tier lower than that of the business unit to which the user belongs.

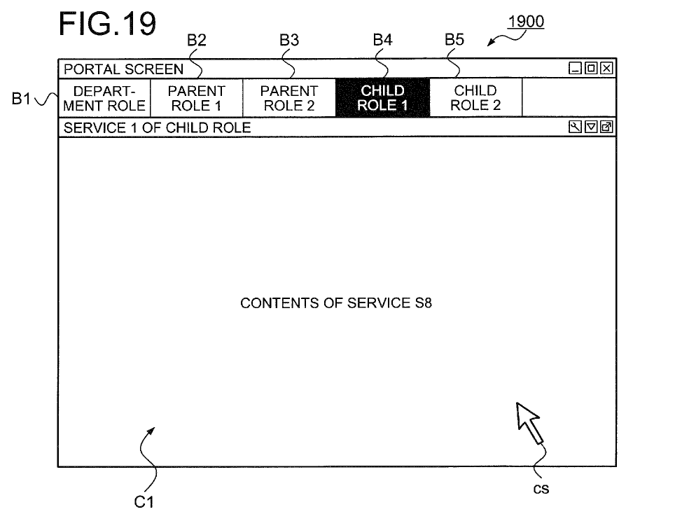

FIG. 19 is an explanatory diagram (Part II) of an example of a screen of the portal screen. In FIG. 19, a portal screen 1900 is an example of a screen that displays contents concerning a service available to a user belonging to the business unit “Department D”.

On the portal screen 1900, a cursor cs is moved to click any one among buttons B1 to B5, whereby according to the button clicked, a service that is available to the members belonging to a role (business unit) is displayed.

In the example of FIG. 19, as a result of clicking of the button B4 on the portal screen 1900, the content Cl is displayed that concerns the service S8 available to the members of a child role 1 “Section H”. The child role 1 is a child role of the business unit “Department D”.

On the portal screen 1900, when the button B1 is clicked, content that concerns the service S4 available to the members of the role “Department D” to which the user belongs is displayed. On the portal screen 1900, when the button B2 is clicked, content that concerns the service S2 available to the members of a parent role 1 “Division B” is displayed. The parent role 1 is the parent role of the business unit “Department D” to which the user belongs.

On the portal screen 1900, when the button B3 is clicked, content that concerns the service S1 available to the members of a parent role 2 “Company A” is displayed. The parent role 2 is the parent role of the parent role “Division B” of the business unit “Department D” to which the user belongs. On the portal screen 1900, when the button B5 is clicked, content that concerns the service S9 available to the members of a child role 2 “Section I” is displayed. The child role 2 is the child role of the role “Department D” to which the user belongs.

According to the portal screen 1900, the user belonging to the business unit “Department D” can refer to the contents concerning the services S1, S2, S4, S8, and S9 available for the business unit “Department D” to which the user belongs, the business units “Division B and Company A” that are higher-order organizations of the business unit “Department D”, and the business units “Sections H and I” that are the subordinate organizations of the business unit “Department D”.

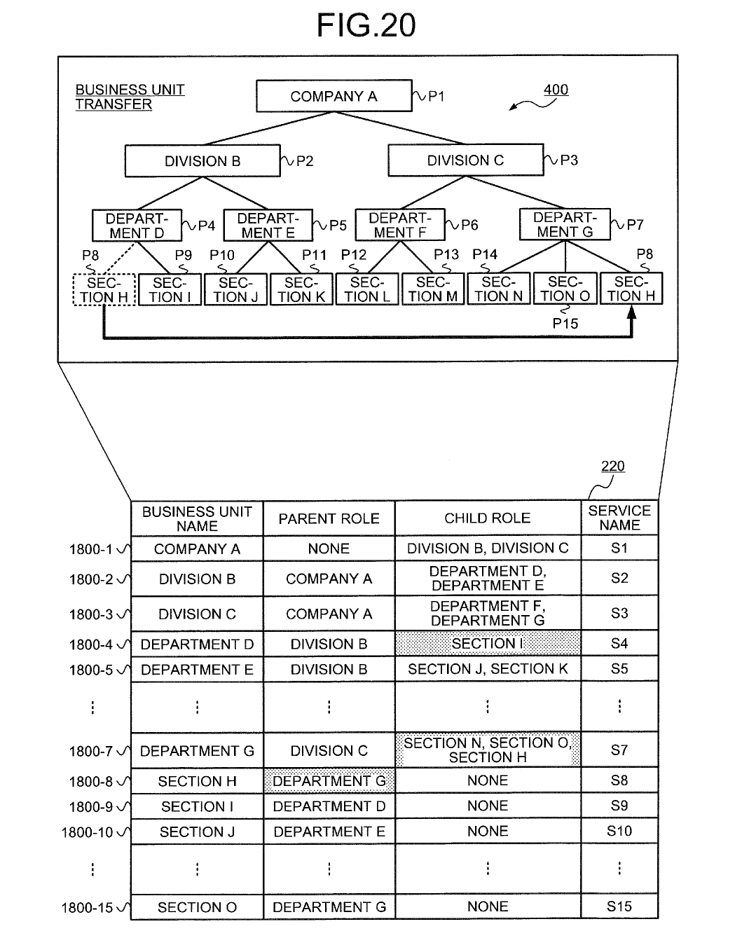

Examples of updating of the storage contents of the role information DB 220 when an organizational change in the organizational structure 400 is executed will be described with reference to FIGS. 20 to 23.

FIG. 20 is an explanatory diagram (Part I) of an example of updating of the storage contents of the role information DB 220 according to the third embodiment. The example depicted in FIG. 20 is the example for a case where the business unit “Section H” that is a subordinate organization of the business unit “Department D” is transferred to be a subordinate organization of the business unit “Department G”.

When the updating unit 806 receives an organizational change notification notifying that the business unit “Section H” that is the subordinate organization of the business unit “Department D” is transferred to be a subordinate organization of the business unit “Department G”, the updating unit 806 acquires from the role information DB 220, the role information 1800-8 whose business unit name field has entered therein the business unit name “Section H”, and enters the business unit name “Department G” in the parent role field of the acquired role information 1800-8.

In this case, when a child role is present for the business unit “Section H” as a result of the transfer of the business unit “Section H” to be a subordinate organization of the business unit “Department G”, the updating 806 enters the business unit name in the child role field of the role information 1800-8. In the example of FIG. 20, no child role is present and therefore, the child role field of the role information 1800-8 still has “None” entered therein.

The updating unit 806 acquires from the role information DB 220, the role information 1800-7 whose business unit name field has entered therein the business unit name “Department G”, and adds the business unit name “Section H” into the child role field of the acquired role information 1800-7.

The updating unit 806 acquires from the roll information DB 220, the role information 1800-4 whose business unit name field has entered therein the business unit name “Department D”, and deletes the business unit name “Section H” entered in the child role field of the acquired role information 1800-4.

Thus, the role information whose parent and child roles are changed accompanying the transfer of the business unit in the company can be updated.

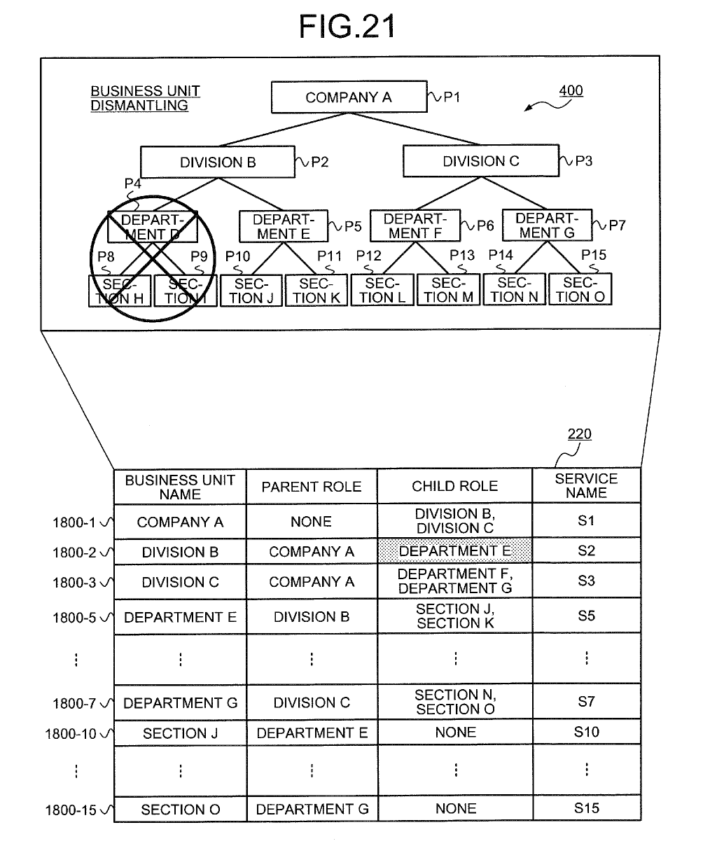

FIG. 21 is an explanatory diagram (Part II) of an example of updating of the storage contents of the role information DB 220 according to the third embodiment. The example depicted in FIG. 21 is an example for a case where the business unit “Department D” is dismantled. The business units “Sections H and I” that are the subordinate organizations of the business unit “Department D” are also dismantled accompanying the dismantling of the business unit “Department D”.

When the updating unit 806 receives an organizational change notification notifying that the business units “Department D” and “Sections H and I” that are subordinate organizations of the business unit “Division B” are dismantled, the updating unit 806 deletes from the role information DB 220, the records of role information 1800-4, 1800-8, and 1800-9 whose business unit name fields have entered therein the business unit names “Department D” and “Sections H and I”.

The updating unit 806 acquires from the role information DB 220, the role information 1800-2 whose business unit name field has entered therein the business unit name “Division B” and deletes the business unit name “Department D” entered in the child role field of the acquired role information 1800-2.

Thus, the role information of the business unit to be dismantled can be deleted from the role information DB 220 simultaneously with the dismantling of the business unit in the company. The role information whose child role is changed accompanying the dismantling of the business unit of the company, can be updated.

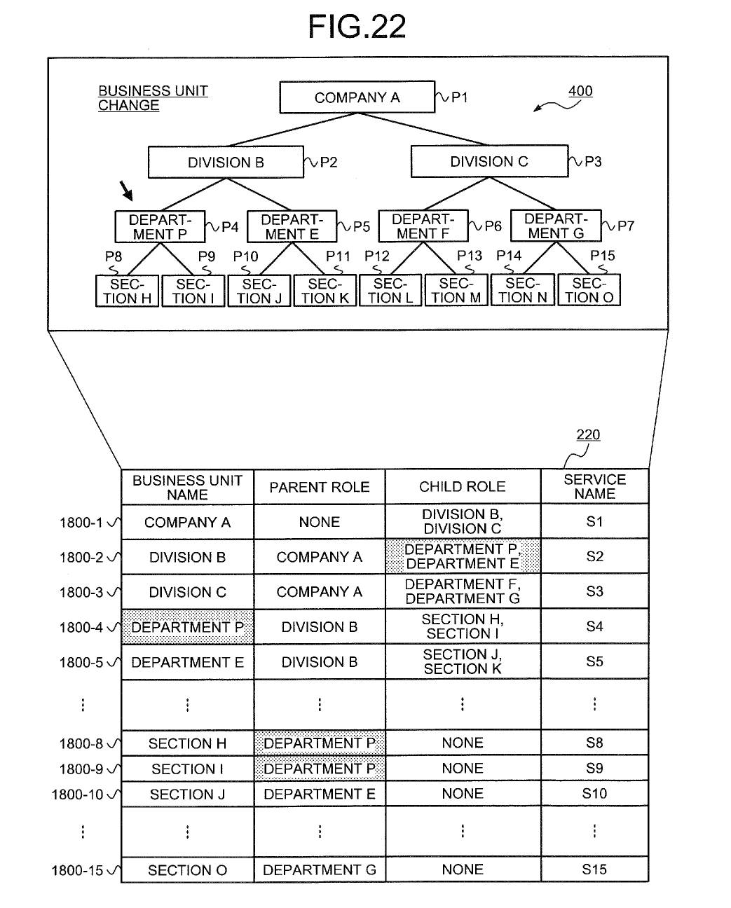

FIG. 22 is an explanatory diagram (Part III) of an example of updating of the storage contents of the role information DB 220 according to the third embodiment. The example depicted in FIG. 22 is the example for a case where the business unit name of the business unit “Department D” is changed. In this case, it is assumed that the business unit name after the change is “P Department”.

When the updating unit 806 receives an organizational change notification notifying that the business unit name of the business unit “Department D” that is a subordinate organization of the business unit “Division B” is changed to “P Department”, the updating unit 806 acquires from the role information DB 220, the role information 1800-4 whose business unit name field has entered therein the business unit name “Department D” and enters the business unit name after the change “P Department” into the business unit name field of the acquired role information 1800-4.

Thus, the role information whose business unit name field has entered therein the business unit name of the business unit to be changed, can be updated simultaneously with the change of the business unit name of the business unit in the company.

The updating unit 806 acquires from the role information DB 220, the records of role information 1800-8 and 1800-9 whose parent role fields have entered therein the business unit name “Department D”, and enters the new business unit name “P Department” into the parent role fields of the acquired records of role information 1800-8 and 1800-9.

Thus, the role information whose parent role field has entered therein the business unit name of the business unit to be changed can be updated simultaneously with the change of the business unit name of the business unit in the company.

The updating unit 806 acquires from the role information DB 220, the role information 1800-2 whose child role field has entered therein the business unit name “Department D”, and changes the business unit name “Department D” entered in the child role field of the acquired role information 1800-2 to the business unit name “P Department”.

Thus, the role information whose child role field has entered therein the business unit name of the business unit to be changed, can be updated simultaneously with the change of the business unit name of the business unit in the company.

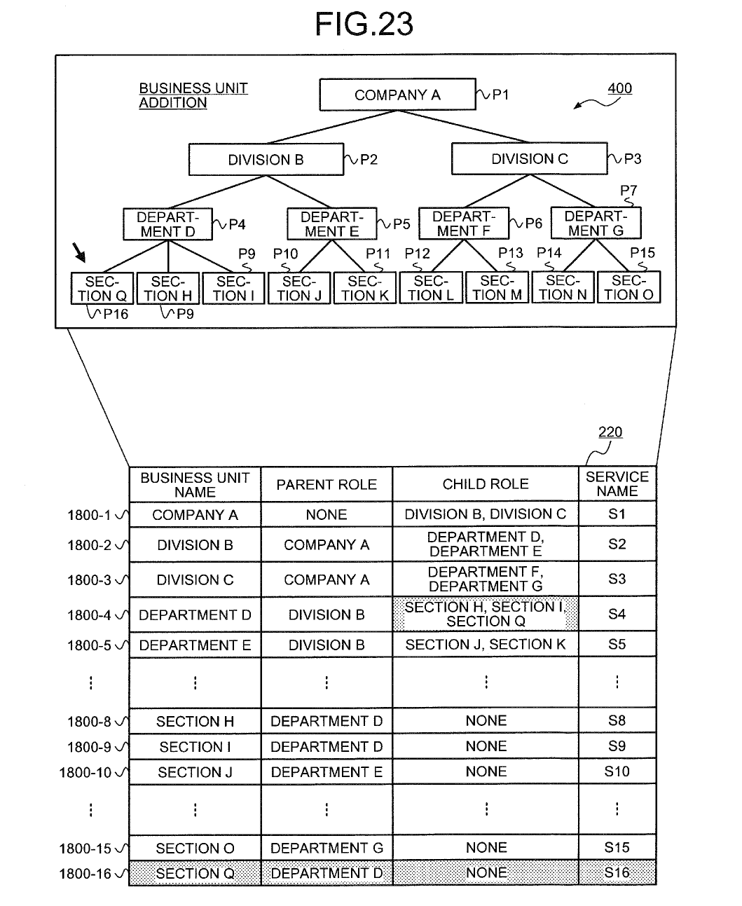

FIG. 23 is an explanatory diagram (Part IV) of an example of updating of the storage contents of the role information DB 220 according to the third embodiment. The example depicted in FIG. 23 is an example for the case where a new business unit “Q Section” is added as a subordinate organization of the business unit “Department D”.

When the updating unit 806 receives an organizational change notification notifying that the new business unit “Q Section” is added as a subordinate organization of the business unit “Department D”, the updating unit 806 newly registers role information 1800-16 into the role information DB 220. Thus, the role information of the new business unit can newly be registered simultaneously with the addition of the new business unit of the company.

The updating unit 806 acquires from the role information DB 220, the role information 1800-4 whose business unit name field has entered therein the business unit name “Department D” and adds the business unit name “Q Section” into the child role field of the acquired role information 1800-4. Thus, the role information of the parent role of the new business unit can be updated simultaneously with the addition of the new business unit of the company.

An information provision process procedure of the information providing apparatus 101 according to the third embodiment will be described.

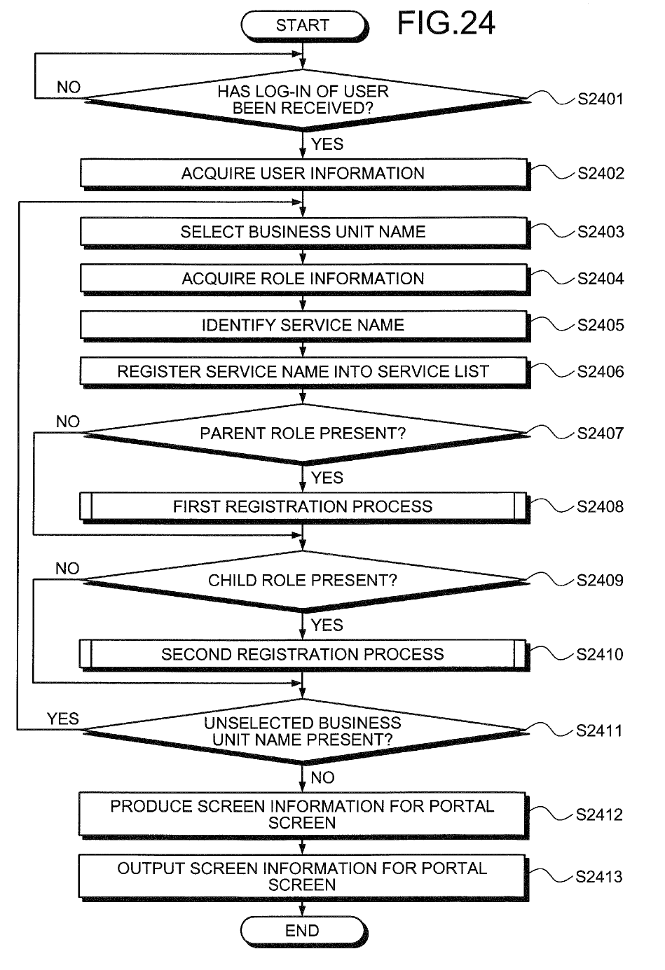

FIG. 24 is a flowchart of an example of the information provision process procedure of the information providing apparatus 101 according to the third embodiment. In the flowchart of FIG. 24, the information providing apparatus 101 determines whether log-in of the user from the client apparatus 201 has been received (step S2401).

The information providing apparatus 101 waits for log-in of the user to be received (step S2401: NO). Upon receiving the log-in of the user (step S2401: YES), the information providing apparatus 101 acquires from the user information DB 210, the user information of the user (step S2402).

The information providing apparatus 101 selects the business unit name entered in the business unit name field of the acquired user information (step S2403) and acquires from the role information DB 220, the role information whose business unit name field has entered therein the selected business unit name (step S2404).

The information providing apparatus 101 identifies the service name entered in the service name field of the acquired role information (step S2405), registers the identified service name into the service list 900 (step S2406), and determines whether a parent role is present by referring to the acquired role information (step S2407).

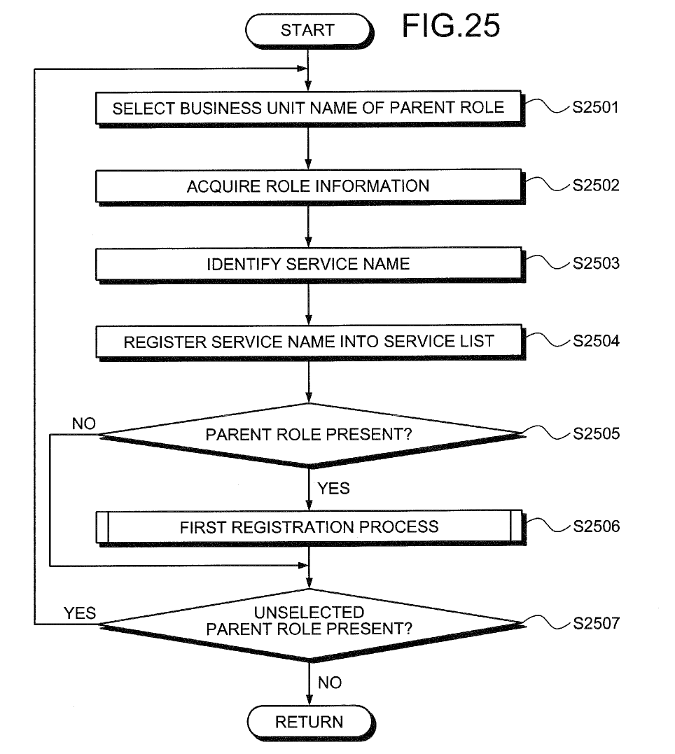

If the information providing apparatus 101 determines that no parent role is present (step S2407: NO), the information providing apparatus 101 proceeds to step S2409. On the other hand, if the information providing apparatus 101 determines that a parent role is present (step S2407: YES), the information providing apparatus 101 executes a first registration process (step S2408). The specific process procedure of the first registration process will be described with reference to FIG. 25.

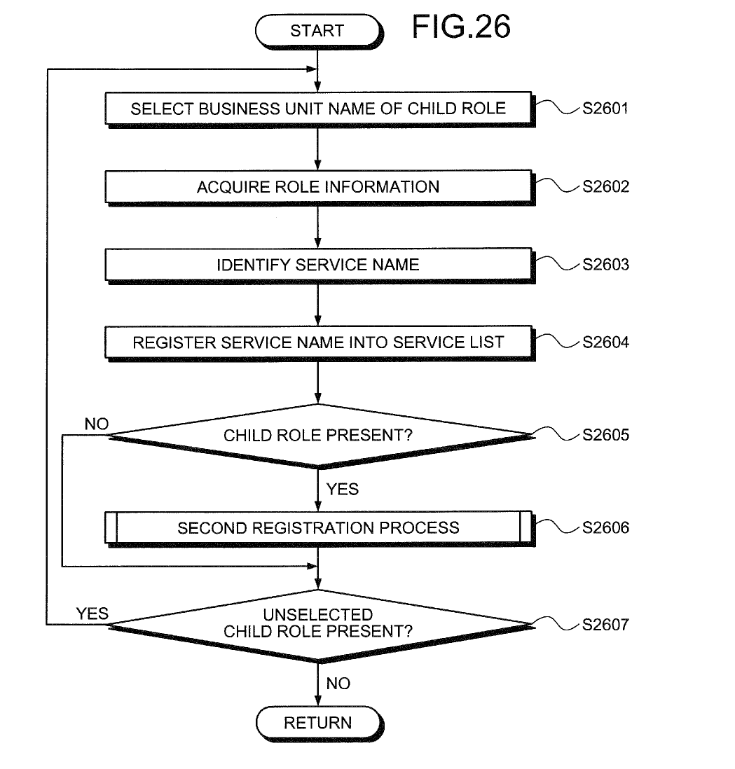

The information providing apparatus 101 determines whether a child role is present, by referring to the acquired role information (step S2409). If the information providing apparatus 101 determines that no child role is present (step S2409: NO), the information providing apparatus 101 proceeds to step S2411. On the other hand, if the information providing apparatus 101 determines that a child role is present (step S2409: YES), the information providing apparatus 101 executes a second registration process (step S2410). The specific process procedure of the second registration process will be described with reference to FIG. 26.

The information providing apparatus 101 determines whether an unselected business unit name that is entered in the business unit name field of the acquired user information is present (step S2411). If the information providing apparatus 101 determines that an unselected business unit name is present (step S2411: YES), the information providing apparatus 101 returns to step S2403 and selects the unselected business unit name entered in the business unit name field of the acquired user information (step S2403).

On the other hand, if the information providing apparatus 101 determines that no unselected business unit name is present (step S2411: NO), the information providing apparatus 101 refers to the service list 900, produces screen information concerning the portal screen to display thereon the contents concerning the services available to the user (step S2412), outputs the produced screen information concerning the portal screen to the client apparatus 201 (step S2413), and causes the series of operations according to this flowchart to come to an end.

Thus, when log-in of the user is received, the screen information concerning the portal screen to display thereon the content concerning the services available to the user can be provided for the client apparatus 201.

The specific process procedure of the first registration process at step S2408 depicted in FIG. 24 will be described.

FIG. 25 is a flowchart of an example of the specific process procedure of the first registration process. In the flowchart of FIG. 25, the information providing apparatus 101 selects the business unit name of the parent role entered in the parent role field of the acquired role information (step S2501) and acquires from the role information DB 220, the role information whose business unit name field has entered therein the business unit name of the selected parent role (step S2502).

The information providing apparatus 101 identifies the service name entered in the service name field of the acquired role information (step S2503), registers the identified service name into the service list 900 (step S2504), and determines whether a parent role is present, by referring to the acquired role information (step S2505).

If the information providing apparatus 101 determines that no parent role is present (step S2505: NO), the information providing apparatus 101 proceeds to step S2507. On the other hand, if the information providing apparatus 101 determines that a parent role is present (step S2505: YES), the information providing apparatus 101 executes the first registration process (step S2506).

The information providing apparatus 101 determines whether a business unit name of an unselected parent role is present that is entered in the parent role field of the role information (step S2507). If the information providing apparatus 101 determines that a business unit name of an unselected parent role is present (step S2507: YES), the information providing apparatus 101 returns to step S2501 and selects the business unit name of the unselected parent role entered in the parent role field of the role information (step S2501).

On the other hand, if the information providing apparatus 101 determines that no business unit name of an unselected parent role is present (step S2507: NO), the information providing apparatus 101 causes the series of operations according to this flowchart to come to an end and returns to the process step at which the information providing apparatus 101 invokes the first registration process.

Thus, the services that are available to the members of the business unit represented by the parent role can be identified recursively, until no parent role is present of the target business unit for which available services are to be identified.

The specific process procedure of the second registration process at step S2410 depicted in FIG. 24 will be described.

FIG. 26 is a flowchart of an example of the specific process procedure of the second registration process. In the flowchart of FIG. 26, the information providing apparatus 101 selects the business unit name of the child role entered in the child role field of the acquired role information (step S2601) and acquires the role information whose business unit name field has entered therein the business unit name of the selected child role (step S2602).

The information providing apparatus 101 identifies the service name entered in the service name field of the acquired role information (step S2603), registers the identified service name into the service list 900 (step S2604), and determines whether a child role is present, by referring to the acquired role information (step S2605).

If the information providing apparatus 101 determines that no child role is present (step S2605: NO), the information providing apparatus 101 proceeds to step S2607. On the other hand, if the information providing apparatus 101 determines that a child role is present (step S2605: YES), the information providing apparatus 101 executes the second registration process (step S2606).

The information providing apparatus 101 determines whether a business unit name of an unselected child role is present that is entered in the child role field of the role information (step S2607). If the information providing apparatus 101 determines that a business unit name of an unselected child role is present (step S2607: YES), the information providing apparatus 101 returns to step S2601 and selects the business unit name of the unselected child role entered in the child role field of the role information (step S2601).

On the other hand, if the information providing apparatus 101 determines that no business unit name of an unselected child role is present (step S2607: NO), the information providing apparatus 101 causes the series of operations according to this flowchart to come to an end and returns to the process step at which the information providing apparatus 101 invokes the second registration process.

Thus, the services that are available to the members of the business unit represented by the child role can be identified recursively until no child role is present of the target business unit for which the available services are to be identified.

According to the information providing apparatus 101 according to the third embodiment, by referring to the role information DB 220, the service name of the service that is available to the members of the target business unit can be identified using the business unit to which the user belongs as the target business unit for which services are to be identified. According to the information providing apparatus 101, when a parent role is present for the target business unit, the service name of the service that is available to the members of the target business unit can be identified using the parent role as the target business unit; and when a child role is present for the target business unit, the service name of the service that is available to the members of the target business unit can be identified using the child role as the target business unit for which services are to be identified.

Thus, services can be identified as the services available to the user such as those available to the members of the business units from the business unit to which the user belongs, up to the highest-order business unit and to the lowest-order business unit.

According to the information providing apparatus 101, when a change notification is received that given notification of the details of a change in the organizational structure as a result of the change of the organizational structure of the organization, the storage contents of the role information DB 220 can be updated based on the change notification. Thus, the work load on the worker, necessary for changing the role information accompanying the change of the organizational structure, can be reduced.

According to the information providing apparatus 101, when a change notification is received that gives notification of the details of a change in the organizational structure as a result of the change of the organizational structure of the organization, the storage contents of the user information DB 210 can be updated based on the change notification. Thus, the work load on the worker, necessary for changing the user information accompanying the change of the organizational structure can be reduced.

As described, according to the information providing program, the information providing method, and the information providing apparatus of the embodiments, by regarding only the business unit to which the user belongs as a role, the work load necessary to change the user information and the role information when the organizational structure is changed, can be reduced. By facilitating reduction of the working time necessary for changing the user information and the role information, services corresponding to the business unit to which the user belongs when the organizational structure is changed, can be provided quickly.

The information providing method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

According to an aspect of the present invention, the work load that is necessary for identifying services to be provided to users when the organizational structure is changed can be reduced.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium storing an information providing program causing a computer to execute a process comprising:
acquiring user information that indicates a business unit to which a user belongs in an organizational structure hierarchically structured by a plurality of business units;
identifying information concerning a first service available to a member of the business unit to which the user belongs as indicated by the acquired user information, by referring to storage contents of a storage unit correlating and storing information concerning a service available to members of the business unit and information concerning the business units in neighboring tiers adjacent to a tier of the business unit;
identifying information concerning a second service available to a member of a second business unit in a first neighboring tier adjacent to the tier of the business unit to which the user belongs, by referring to the storage contents of the storage unit; and
correlating and outputting the identified information concerning the first service and the identified information concerning the second service.

2. The recording medium according to claim 1, the process comprising
identifying by referring to the storage contents of the storage unit and when a third business unit is further present in a second neighboring tier adjacent to the first neighboring tier, information concerning a third service available to a member of the third business unit, wherein
the correlating and outputting includes correlating and outputting the identified information concerning the first service, the identified information concerning the second service, and the identified information concerning the third service.

3. The recording medium according to claim 2, the process comprising:
producing screen information to display contents concerning a service available to the user based on the information concerning the first, the second, and the third services; and
outputting the produced screen information.

4. The recording medium according to claim 1, the process comprising
updating the storage contents of the storage unit, when a change notification is received giving notification of details of a change in the organization structure, the storage contents being updated based on the change notification.

5. The recording medium according to claim 1, the process comprising
receiving identification information of the user, wherein
the acquiring includes acquiring from the storage unit correlating and storing for each of the business units, user information indicating identification information concerning members belonging to the business unit, the user information corresponding to the received identification information of the user.

6. The recording medium according to claim 1, wherein
the storage unit correlates and stores the information concerning a service available to members of the business unit and information concerning the business units in a higher tier adjacent to the tier of the business unit,
the identifying the first service includes identifying the information concerning the first service that is available to a member of the business unit to which the user belongs as indicated by the user information, by referring to the storage contents of the storage unit, and
the identifying the second service includes identifying the information concerning the second service that is available to a member of the second business unit in the higher tier adjacent to the tier of the business unit to which the user belongs, by referring to the storage contents of the storage unit.

7. The recording medium according to claim 6, wherein
the identifying the third service includes identifying by referring to the storage contents of the storage unit and when a third business unit is further present in a second higher tier adjacent to the higher tier, information concerning the third service.

8. An information providing method executed by a computer, the information providing method comprising:
acquiring user information that indicates a business unit to which a user belongs in an organizational structure hierarchically structured by a plurality of business units;
identifying information concerning a first service available to a member of the business unit to which the user belongs as indicated by the acquired user information, by referring to storage contents of a storage unit correlating and storing information concerning a service available to members of the business unit and information concerning the business units in neighboring tiers adjacent to a tier of the business unit;
identifying information concerning a second service available to a member of a second business unit in a first neighboring tier adjacent to the tier of the business unit to which the user belongs, by referring to the storage contents of the storage unit; and
correlating and outputting the identified information concerning the first service and the identified information concerning the second service.

9. An information providing apparatus comprising:
a processor programmed to:
acquire user information that indicates a business unit to which a user belongs in an organizational structure hierarchically structured by a plurality of business units;
identify information concerning a first service available to a member of the business unit to which the user belongs as indicated by the acquired user information, by referring to storage contents of a storage unit correlating and storing information concerning a service available to members of the business unit and information concerning the business units in neighboring tiers adjacent to a tier of the business unit;
identify information concerning a second service available to a member of a second business unit in a first neighboring tier adjacent to the tier of the business unit to which the user belongs, by referring to the storage contents of the storage unit; and
correlate and output the identified information concerning the first service and the identified information concerning the second service.
